(19) United States
(12) Patent Application Publication
(10) Pub. No.: US 2022/0412040 A1
(43) Pub. Date: Dec. 29, 2022

(54) SYSTEM AND METHOD FOR LOCALIZING AN ATTACHMENT TOOL

(71) Applicant: Liebherr-Hydraulikbagger GmbH, Kirchdorf/Iller (DE)

(72) Inventors: Thomas ZITTERBART, Dietenheim (DE); Katharina SCHICK, Memmingen (DE)

(21) Appl. No.: 17/844,527

(22) Filed: Jun. 20, 2022

(30) Foreign Application Priority Data
Jun. 23, 2021 (DE) 102021116246.7

(51) Int. Cl. E02F 3/43; E02F 3/36; E02F 9/26

(52) U.S. Cl. CPC E02F 3/431; E02F 3/3604; E02F 9/26

(57) ABSTRACT

The invention relates to a system for localizing an attachment tool for a work device comprising a first communication unit connect to an attachment tool and having a first acceleration sensor that is configured to provide a first acceleration signal relating to an instantaneous acceleration of the attachment tool; a second communication unit connected to the work device in the region of a connection region for the attachment tool and having a second acceleration sensor that is configured to provide a second acceleration signal relating to an instantaneous acceleration of the connection region; and an identification module that is coupled to the first and/or second communication unit(s) and that is configured to obtain the first and second acceleration signals and to enable a safe allocation of the attachment tool to the work device by evaluating the signals. The invention further relates to a set of a work device and an attachment tool having a system in accordance with the invention and to a method of localizing an attachment tool for a work device with the aid of a system in accordance with the invention.

### CROSS-REFERENCE TO RELATED APPLICATIONS

This application claims priority to German Patent Application No. 10 2021 116 246.7 (filed 23 Jun. 2021), the entire disclosure of which is incorporated herein by reference.

### BACKGROUND

### Technical Field

The present invention relates to a system for localizing or associating an attachment tool for a work device having a first communication unit connected to the attachment tool, a second communication unit connected to the work device, and an identification module in communicative connection with the first and/or second communication unit(s). The present invention further relates to a method of verifying or identifying an attachment tool for a work device by means of such a system.

### State of Art

With some work devices such as hydraulic excavators, it is known to keep a number of different attachment tools ready at the deployment site that can be attached to or removed from the work device for carrying out special work on site. Such work devices are typically equipped with a quick-change system to be able to take up and put down the different attachment tools quickly and simply. A plurality of work tools are frequently stored close to one another at the deployment site to be taken up or put down by the work device as required.

To be able to set the operation of the work device to the respective attached tool, it is known to equip the attachment tools with transmission/reception modules that, for example, transmit identification or geometric data to a control of the work device. Due to the wireless transmission and to the fact that the reception modules have a certain range, it does, however, occur again and again that signals are received from a plurality of work tools. Since the data exchanged may well be safety-related, it is necessary to make a correct association of which attachment tool is coupled with which work device.

### BRIEF SUMMARY

It is therefore the underlying object of the present invention to increase the reliability of the association between the attachment tool and the work device.

This object is satisfied in accordance with the invention by a system having the features of claim 1 and by a method having the features of claim 12. Advantageous embodiments of the invention result from the dependent claims and from the following description.

A system for localizing an attachment tool for a work device is accordingly provided, with the work device, for example, being able to be a hydraulic excavator and with the attachment tool, for example, being an excavator bucket, an orange-peel grab, or an arm extension. The invention can, however, also be used with other work devices with which different attachment tools can be used.

The system in accordance with the invention comprises a first communication unit that is connected to an attachment tool. The first communication unit comprises a first acceleration sensor by means of which an instantaneous acceleration of the attachment tool can be detected and is configured to provide a first acceleration signal representing the acceleration.

The system in accordance with the invention further comprises a second communication unit that is connected to the work device, and indeed in the region of a connection region for attaching the attachment tool. The connection region can be arranged at the end of an excavator arm and can, for example, represent or comprise a quick-changer. The second communication unit comprises a second acceleration sensor by means of which an instantaneous acceleration of the connection region can be detected and is configured to provide a second acceleration signal that represents the detected acceleration of the connection region.

The system in accordance with the invention furthermore comprises an identification module that is coupled with the first and/or with the second communication unit. The identification module is configured to receive or to obtain the first and second acceleration signals and to compare them with one another to localize and associate the attachment tool with reference to this comparison. The identification module can in particular recognize with reference to the aforesaid comparison whether a certain attachment tool is connected to the work device, i.e. is attached to the connection region, or whether it is, for example, placed on the ground or at a second work device in the environment. The identification module can be a software module or a program.

The idea in accordance with the invention therefore comprises achieving a safe and reliable association or identification of an attachment tool in that the accelerations of the attachment tool and the connection region are measured and evaluated, i.e. are compared with one another. If the attachment tool whose signals (first acceleration signal) are received from the work device (or from the second communication unit) is installed at the connection region, the attachment tool and the connection region undergo a similar acceleration on a movement of the connection region. If only the attachment tool is moved, the latter likewise undergoes an acceleration. Conversely, an attachment tool placed down on the ground does not undergo any acceleration.

If, for example, the second communication unit now receives two first acceleration signals from two different attachment tools of which one is attached to the connection region and the other is placed down on the ground, the acceleration that is represented by one of the two first acceleration signals will be more similar to the acceleration of the connection region (represented by the second acceleration signal) than the acceleration that is represented by the other acceleration signal during a movement of the connection region (for example a pivoting of an excavator arm).

If only the attachment tool is moved (e.g. pivoted relative to the connection region), the acceleration that is represented by one of the two first acceleration signals is greater than the acceleration that is represented by the other first acceleration signal.

It is therefore advantageous for a reliable association of the attached attachment tool that the connection region or at least the attachment tool is moved so that a sufficient difference results in the acceleration between stationary and attached attachment tools. The automatic identification of the respectively attached attachment tool achieved by the system in accordance with the invention in particular does not here serve the selection of the correct attachment tool by the operator or by a corresponding operating aid but should rather ensure that a control of the work device, for example, only receives data relevant to the operation from the attached work tool and not from non-attached work tools likewise located in range. The automatic identification or association can thus in particular take place automatically directly after the attachment or the picking up of the attachment tool as soon as a movement or acceleration of the connection region and/or attachment tool takes place.

However, an association is also theoretically possible without an acceleration of the attached attachment tool by means of the system in accordance with the invention, for example in that the signal strengths of the wireless connections are compared with one another. It is assumed here that the attachment tool attached to the connection region is closer to the connection region than other attachment tools and thus that the first acceleration signal of the corresponding first communication unit is stronger, i.e. has a higher amplitude, than the signals of the other attachment tools.

However, a comparison of the acceleration signals preferably takes place during a movement of the attached attachment tool so that the “correct” first acceleration signal represents an acceleration greater than zero. This movement can be a movement that occurs automatically on the mechanical coupling procedure so that a suitable evaluation can take place automatically here. The comparison of the acceleration signals or the association of an attachment tool preferably takes place automatically so that the operator does not have to do anything more here.

Provision is made in a possible embodiment that the first communication unit is configured to transmit the first acceleration signal wirelessly to a reception unit, for example via RFID or Bluetooth, preferably BLE (Bluetooth Low Energy). The reception unit is preferably configured to receive signals within a limited reception radius. In the case of BLE, this can amount to a plurality of meters so that signals of a plurality of attachment tools can be simultaneously received. Conversely, the first communication device in particular has a limited transmission radius that can likewise amount to some meters.

Provision is made in a further possible embodiment that the second communication unit comprises the reception unit and is configured to provide the first and second acceleration signals to the identification module for example via cable or wirelessly. The reception unit can be integrated in the second communication unit.

One possibility is that the second communication unit comprises the identification module. The identification module can here be a software module that is stored in a data store of the second communication unit. In this case, the comparison of the acceleration signals, i.e. the evaluation, is carried out locally in the second communication unit. The second communication unit can furthermore be connected to a control of the work device so that the control and the second communication unit can exchange data. Provision can in particular be made that data of the identified attachment tool that are provided via the first communication unit can be transmitted to the control via the second communication unit (interface to the control).

A further possibility comprises a separate identification unit being provided that is connected to the work device and that comprises the identification module and is configured to receive the first and second acceleration signals from the second communication unit in a wired or wireless manner. The identification unit here does not have to be arranged in the region of the connection region but can rather be located at any desired point of the work device, for example at or in a superstructure of the work device or in an operator's cabin. In this case, the different signals of the communication units converge centrally in the identification unit where the evaluation or the comparison of the acceleration signals inter alia takes place.

The identification unit can comprise a data store on which the identification module is stored as a software module. The identification unit can furthermore be connected to a control of the work device so that the control and the identification unit can exchange data. Provision can in particular be made that data of the identified attachment tool that are provided via the first communication unit can be transmitted to the control via the identification unit (interface to the control).

The second communication unit and the identification unit are preferably wirelessly connected to one another. Alternatively, these two units can be connected to one another by cable, with the cable being able to be led along the arm up to the connection region in the case of an excavator. Such a cabling can be dispensed with in a wireless connection.

Alternatively, the identification unit can be a mobile device, for example a smartphone or a tablet, and the identification module can be a program running on such a mobile device. It is likewise conceivable that the identification unit is an external processing unit or a cloud. The mobile device or the cloud can be communicatively connected to the cloud wirelessly, for example by cellular radio, using a corresponding transmission and reception unit that is in turn connected to or integrated in the second communication unit wirelessly or by cable.

Provision is likewise made in a further possible embodiment that an identification unit connected to the work device is provided. In this embodiment, however, the identification module comprises the reception unit, i.e. the first communication unit communicates directly with the identification unit. In this case, the second communication unit is configured to transmit the second acceleration signal to the identification unit in a wired or wireless manner. The optional design possibilities described with respect to the previous embodiment apply analogously to this embodiment.

Provision is made in a further possible embodiment that the first communication unit is configured to provide an identification signal and to transmit it to the identification module and/or to a control of the work device.

The identification signal can relate to a location of the attachment tool that can, for example, be detectable by means of a position detection module (e.g. a GPS module). Alternatively or additionally, the identification signal can relate to a dimension or to a plurality of dimensions or to a geometry of the attachment tool. Alternatively or additionally, the identification tool can relate to a type of attachment tool, i.e. can characterize the attachment tool (e.g. an excavator bucket, an orange peel grab, etc.). Alternatively or additionally, the identification signal can relate to another property of the attachment tool such as a weight, a tool parameter, etc. Operating parameters can also be transmitted.

The identification signal can preferably be provided to the control that thereupon adapts the operation of the work device to the respective recognized, attached attachment tool. Since the data represented by the identification signal may be safety-related, it is particularly important that only the data of the actually attached attachment tool are transmitted to the control, which is ensured with the aid of the system in accordance with the invention.

Provision is made in a further possible embodiment that the identification module is configured to take account of one or more of the following pieces of information in the comparison of the first and second acceleration signals.
A property of the first and/or second acceleration signals. It can here preferably be the signal strengths or amplitudes of the acceleration signals, in particular of the first acceleration signals. It can be an indication of the distance of the respective attachment tool from the connection region (the larger the distance, the smaller the signal strength);
A property of the identification signal. It can here preferably be the signal strength or amplitude of the identification signal;
An instantaneous location of the attachment tool. It can be determinable by means of a location determination unit (e.g. a GPS module) arranged at the attachment tool;
A position or arrangement of the first communication unit at an attachment tool. A more exact calculation can be made on the basis of this information as to which accelerations can be expected at the attachment tool in the coupling procedure and during operation and a higher accuracy can be achieved in the calculation of an expected acceleration or in the comparison with the actually measured acceleration;
An instantaneous position and/or an instantaneous equipment state of the work device. It/They can be determinable by means of at least one sensor of the work device. The position can relate, for example, to the position or orientation of an excavator arm; and
An instantaneous coupling state of the attachment tool with the connection region of the work device. It can be determinable by means of a coupling sensor that, for example, detects that an attachment tool is coupled to the connection region.

It is thereby possible to further increase the accuracy or reliability of the localization of the attached attachment tool.

Provision is made in a further possible embodiment that the identification module is configured to receive a plurality of acceleration signals from first communication units of a plurality of attachment tools and to compare each of these first acceleration signals with a second acceleration signal (either with a single second acceleration signal as a reference or with a plurality of second acceleration signals) of the second communication unit to determine with reference to the comparisons whether an attachment tool has been connected to the work device and/or which of the attachment tools is connected to the work device. The second communication unit can preferably receive acceleration signals from attachment tools within a certain reception radius of, for example, a plurality of meters.

Provision is made in a further possible embodiment that the identification module is configured to take account of which of the attachment tools is connected to the work device and of a smallest difference between a first acceleration signal and a second acceleration signal in the determination of whether an attachment tool is connected to the work device and as to which of the attachment tools is connected to the work device. The difference can relate to different properties of the acceleration signal such as the signal strength or amplitude. The difference preferably relates to the accelerations of the observed attachment tools and of the connection region. In other words, that attachment tool is recognized as attached (or is at least weighted more with respect to a likelihood that it is an attached tool) whose acceleration most agrees with the measured acceleration of the connection region, for example has the smallest difference.

Alternatively or additionally, the identification module can be configured to take account of a distinction in the form of a difference or of any other desired evaluation algorithm of the signal between a second acceleration signal and an expected acceleration for an attachment tool calculated with reference to the second acceleration signal in said determination. An acceleration for an attached attachment tool that can be theoretically expected is therefore calculated using the acceleration of the connection region measured by means of the second acceleration sensor and is compared with the acceleration of the attached attachment tool actually measured by means of the first acceleration sensor. In this process, date on the attachment tool that are transmitted by the first communication unit (e.g. on the geometry of the tool) can be taken into account. If the deviation is too high, the work tool is recognized as not attached or is at least weighted less.

Provision is made in a further possible embodiment that at least two first communication units are provided that are connected to different attachment tools that can be coupled with one another and/or with the connection region, with the identification module being configured to obtain the first acceleration signals of the at least two first communication units and to compare them with one another and/or with the second acceleration signal to determine an attachment order of the attachment tools using the comparison. One of the attachment tools can, for example, be an adapter or an extension to which in turn a different attachment tool can be attached.

Which of the attachment tools is located closer to the connection region can now be determined with reference to the previously described criteria, and the attachment order can thereby be determined. For example, on a pivoting of a boom of the work device, the attachment tool arranged further outwardly can undergo a greater acceleration than one installed directly at the connection region. Alternatively or additionally, the signal strength could be looked at since the attachment tool arranged further outwardly has a smaller signal strength than the other attachment tool at the location of the second communication unit. The accelerations that can be expected for the different attachment tools at the different positions could likewise be calculated with reference to a predefined or assumed equipment state of the attachment tools and could be compared with the measured acceleration values. If the difference is too great, the actual attachment order can be recognized.

The exact determination of the attachment or coupling order due to the kinematics of the work device permits an exact setting of the work device or of its control to the attachment tools.

The aforesaid does not only apply to an attachment order, but also to the position of an adjustable attachment tool. An adjustable extension could thus be provided as the attachment tool, for example. Depending on the position, the first acceleration signals can vary with respect to the extension or to a further attachment tool attached thereto. An incorrect installation position of an attachment tool could thus be recognized by a comparison of measured and calculated values. Provision could be made here that a control connected to the identification module outputs a warning (e.g. visually and/or acoustically) and/or intervenes in the control of the work device.

In a further embodiment, at least two first communication units are provided on respective different attachment tools that can additionally communicate with one another. Additional information can thereby be made use of in the determination of the coupling. The tools can additionally exchange their coupling status with one another. They can furthermore store the configuration in which they have been installed, for example when two tools were placed down together.

Provision is made in a further possible embodiment that the identification module is configured to calculate an expected acceleration for an attachment tool on the basis of the second acceleration signal and to compare it with the first acceleration signal of the first communication unit of the attachment tool to recognize with reference to the comparison whether the attachment tool is connected to the work device and/or to carry out a plausibility evaluation for an assumed equipment state of the work device. The plausibility evaluation can relate to values on the attachment device transmitted by the first communication unit, for example on the type, on the dimension, etc. (identification signal).

An evaluation can be made, for example, by the plausibility evaluation whether the transmitted dimensions of an extension (e.g. an arm extension with an excavator) differ from the values derived from the measured data. The plausibility evaluation cannot only relate to the equipment state or to the position/configuration of one or more attached tools, but also to the work device itself. The operating safety of the work device is thereby increased. The plausibility evaluation preferably takes place automatically so that the operator does not have to initiate anything here.

The present invention further relates to a set comprising a work device, in particular an excavator, further in particular a hydraulic excavator, and at least one attachment tool that comprise a system in accordance with the invention. The work device preferably comprises a control that is configured to obtain an identification signal relating to a location and/or to a dimension and/or to the type and/or to another property of the attachment tool and to adapt the operation or the control of the work device on the basis of the identification signal.

It is ensured by the comparison of the accelerations that the identification signal underlying or influencing the control of the work device also actually originates from the attached attachment tool and not from a different tool in the reception range. The data that result from the identification signal can be compared with measured values and checked for correctness or plausibility via an optionally provided plausibility evaluation.

The same advantages and properties result here overall as for the system in accordance with the invention so that a repeat description will be dispensed with at this point.

The present invention further relates to a method of localizing an attachment tool for a work device by means of a system in accordance with the invention comprising the steps:
detecting an instantaneous acceleration of at least one attachment tool by means of a first acceleration sensor of a first communication unit connected to the attachment tool and providing a first acceleration signal;
detecting an instantaneous acceleration of the connection region of the work device by means of the second acceleration sensor of the second communication unit and providing a second acceleration signal;
transmitting the first and second acceleration signals to the identification module; and
comparing the first and second acceleration signals using suitable algorithms to localize the attachment tool, in particular to recognize whether the attachment tool is connected to the work device (or with a plurality of possible attachment tools which one is attached to the connection region).

The same advantages and properties obviously result here as for the system in accordance with the invention so that a repeat description will be dispensed with at this point. The above statements with respect to the possible embodiments of the different components of the system and their interactions therefore apply accordingly.

A movement of the attached attachment tool preferably takes place during the measurement of the instantaneous acceleration of the attachment tool by means of the second acceleration sensor that underlies the comparison so that the corresponding first acceleration signal represents an acceleration greater than zero.

Provision is made in a possible embodiment, of the method that at least two first communication units are provided that are connected to different attachment tools, with the attachment tools being couplable to one another and/or to the connection region. Theoretically expected accelerations of at least two attachment tools can be calculated on the basis of the second acceleration signal and can be compared with the first acceleration signals of the first communication units of the attachment tools and to recognize whether one or more of the attachment tools are connected to the work device and/or to carry out a plausibility evaluation for an assumed equipment state or for an equipment state of the work device transmitted by the first communication unit.

Provision is made in a further possible embodiment of the method to take account of information relating to a location and/or to a dimension and/or to a type and/or to another property of the attachment tools that are preferably transmitted to the identification module by the respective first communication units for the plausibility evaluation. Said information is in particular transmitted as an identification signal, with the latter being able to comprise more information or more signals.

Provision is made in a further possible embodiment of the method that an identification signal relating to a location and/or to a dimension and/or to a type and/or to another property of an attachment tool is provided by the associated first communication unit and that the identification signal is transmitted to a control of the work device (either directly or via the second communication unit) that adapts the operation of the work device based on the identification signal.

### BRIEF DESCRIPTION OF THE DRAWINGS

Further features, details, and advantages of the invention result from the embodiments explained in the following with reference to the Figures. There are shown:

FIG. 1: a side view of a work device with an attached attachment tool in accordance with an embodiment of the invention;

FIG. 2: a side view of three attachment tools with schematically shown transmission regions of the first communication devices;

FIG. 3: the connection region of a work device on the taking up of different attachment tools in side views;

FIG. 4: a side view of a work device with two attached attachment tools in accordance with a further embodiment;

FIG. 5: a side view of the connection region with two attached attachment tools in accordance with a further embodiment;

FIG. 6: the view in accordance with FIG. 4, with acceleration forces acting on the different parts being drawn; and

FIG. 7: a schematic diagram of the different components of the system in accordance with the invention in accordance with an embodiment.

### DETAILED DESCRIPTION

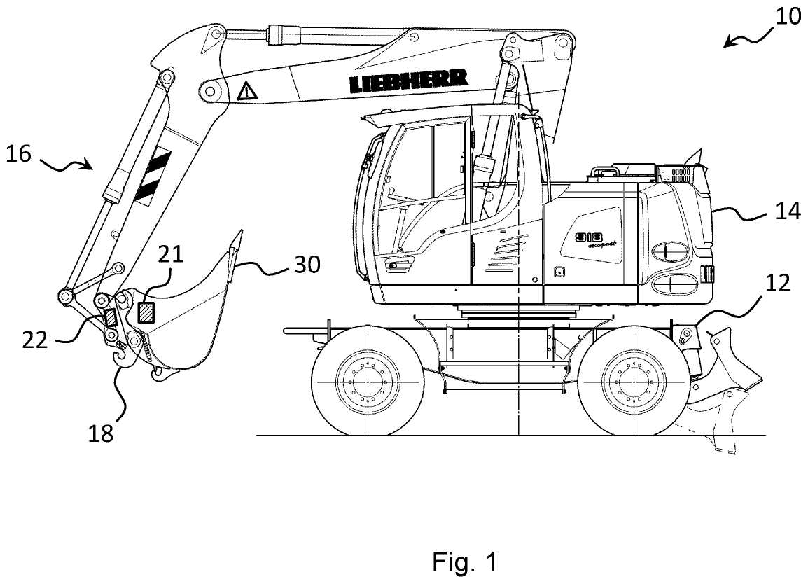

A first embodiment of a work device 10 equipped with the system in accordance with the invention and having an attached attachment tool 30 is shown in a side view in FIG. 1. In the embodiment shown here, it is a hydraulic excavator 10 having an excavator bucket 30 as the attachment tool. The excavator 10 comprises a travelable undercarriage 12, a superstructure 14 rotatably supported on the undercarriage 12, and a pivotable excavator boom 16 at whose end (arm end) a connection region 18 is arranged that is formed as a pivotable quick-changer. The quick-changer 18 enables a fast and uncomplicated attachment and removal or changing of different attachment tools 30 in a manner known per se.

The hydraulic excavator 10 and the excavator bucket 30 (as well as further attachment tools 30 that are optionally available but are not shown in FIG. 1) are equipped with a tool communication and localization system in accordance with the invention. The system comprises a first communication unit 21 (also called a tool module 21 in the following) arranged at the excavator bucket 30, a second communication unit 22 (also called a receiver module 22 in the following) arranged at the quick-changer 18, and an identification unit 24 attached to/in the base device, but not shown in further detail here. The latter has a connection to the vehicle control 26.

The different modules (i.e. the first and second communication units 21, 22 and the identification unit 24) communicate with one another via radio and can exchange data. The first and second communication units 21, 22 preferably communicate by means of Bluetooth (BLE). The signals of the first communication unit 21 are in this respect transmitted to the second communication unit 22 that in turn wirelessly transmits these signals together with signals optionally provided by the second communication unit 22 itself to the identification unit 24. It is therefore possible over this path that signals are transmitted from the first communication unit 21 over the identification unit 24 to the vehicle control 26.

The first and second communication units 21, 22 are additionally equipped with acceleration sensors (not shown) that measure the accelerations of the corresponding parts (that is of the quick-changer 18 and of the excavator bucket 30) at the sites of the communication units 21, 22 and provide corresponding acceleration signals. These acceleration signals converge in the identification unit 24 and are analyzed by corresponding software (identification module) there.

The first and second communication units 21, 22 can comprise corresponding processors, memory modules and transmission and/or reception units.

In addition to the acceleration signals (first acceleration signals), the first communication unit 21 can provide further data relating to the associated attachment tool 30 (e.g. as so-called identification signals) to the second communication unit 22 and thus to the identification unit 24. These data on the tool 30 can, for example, be identification data, geometric data, and/or operating data that are provided to the vehicle control 26 that can then adapt or set the operation of the hydraulic excavator 10 to the respectively attached attachment tool 30.

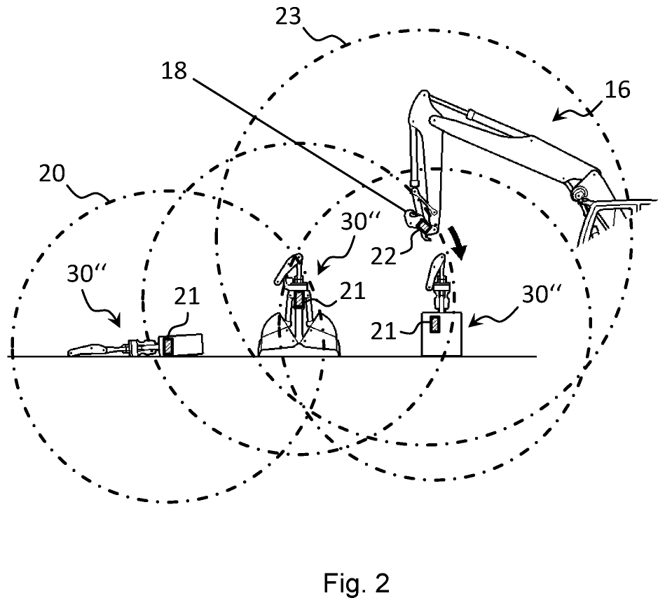

FIG. 2 shows three attachment tools formed as orange-peel grabs 30″ as well as the boom 16 of a hydraulic excavator 10 in a side view.

The wireless coupling of the communication units 21, 22 takes place automatically. Since the first communication units 21 can have a certain transmission range 20 of up to a plurality of centimeters or meters (shown as circles 20 in FIG. 2) and since the second communication unit 22 also has a certain reception range 23 (shown as a circle 23 in FIG. 2), it may occur with a plurality of attachment tools 30″ positioned close to one another that due to the wireless communication the second communication unit 22 is simultaneously coupled with a plurality of first communication units 21 or receives their signals. Each of the corresponding first communication units 21 of the different attachment tools 30″ may now transmit different tool data to the second communication unit 22.

Since these exchanged data may well be safety-related, it is necessary to make a correct association of which tool 30″ is coupled to the base device or connection region 18 after an attachment.

The system in accordance with the invention now provides that an unambiguous and safe identification can be made of which attachment tool 30, 30′, 30″ is coupled to the base device.

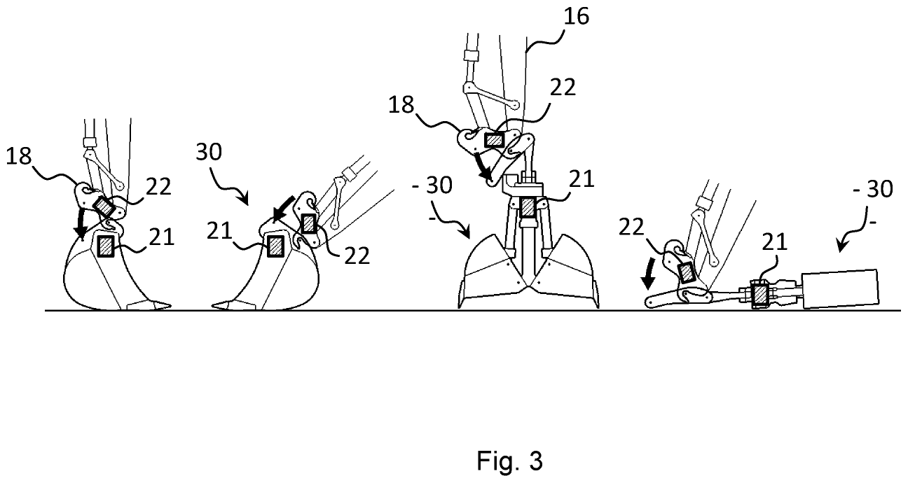

FIG. 3 shows a plurality of examples of possible attachment tools 30, 30′ (here excavation buckets 30 and clam-shell grabs 30″) in a side view that are equipped with corresponding first communication units 21. All these tools 30, 30″ have corresponding connection means via which they can be connected to or gripped by the quick-changer 18.

The second communication unit 22 can be arranged laterally at the quick-changer 18, as illustrated in the embodiments shown here. Alternatively, however, other arrangements are also conceivable, for example centrally at/in the connection region or at an inner side of the quick-changer 18. It is likewise conceivable that the second communication unit 22 is not directly attached to the quick-changer 18, but rather at a different position at the boom 16 or arm.

The attachment tools 30, 30′, 30″ shown here also only show conceivable arrangements of the first communication units 21 in an exemplary and schematic manner. With an excavator bucket 30, it can, as shown, be attached to one of the side walls, with an arrangement at the upper side or at the rear wall also being conceivable, however. With orange-peel grabs 30″, the first communication unit 21 can, for example, be attached to the central middle column (see FIG. 3) in the region of the rotational connection or of the commotion region with the quick-changer 18 or likewise to the grabs themselves (see FIG. 3, far right).

The receiver module 22 at the excavator 10 receives signals of the tool modules 31 disposed in the reception radius 23. If an attachment tool 30, 30′, 30″ is coupled, the received signals are evaluated to identify which of the attachment tools 30, 30′, 30″ located in the radius is the one taken up.

In this respect, the first acceleration signals of the different tool modules 21 are compared by the identification unit 24 with the second acceleration signal provided by the receiver module 22 by means of suitable evaluation methods. If the excavator boom 16 is now moved, acceleration forces that depend on the attachment configuration (equipment state) and on the exact position of the first and second communication units 21, 22 act both on the quick-changer 18 and on the attached tool 30, 30′, 30″. Further attachment tools 30, 30′, 30″ located in the reception range 23 of the second communication unit 22 do not in contrast undergo any acceleration. An identification of the attached tool 30, 30′, 30″ is therefore possible via a comparison of the measured accelerations.

Further signals can additionally be made use of in addition to the acceleration signals for the correct identification or association:
The strength of a communication signal (first acceleration signal and/or identification signal);
The location of the tool 30, 30′, 30″;
Information of the quick-changer 18 on the coupling state;
Information on the position of the excavator 10.

Different signal processing methods can be used in the evaluation of the acceleration signals. It is conceivable, for example, that the signals are smoothed and/or are averaged over a certain time period before they are compared with one another.

It is likewise conceivable that the accelerations are only carried out by means of the accelerations sensor after the picking up of an attachment tool and/or only for a limited time period and/or only for so long until an unambiguous association has taken place. Provision can alternatively be made that the accelerations are measured during the total operation of the work device (e.g. at regular intervals or continuously) to provide corresponding data to the control and/or to the identification module continuously in operation (e.g. for a plausibility check or monitoring taking place regularly).

Suitable methods for evaluating the acceleration signals can comprise the following steps:
The tool module 21 having the smallest difference in acceleration with respect to the reception module 22 is recognized as the coupled module 21;
The expected movement of the tool module 21 on the coupling is calculated in advance on the basis of the movement of the reception module 22 and this calculated acceleration is compared with the received accelerations of the surrounding tool modules 21 located in the reception range 23. The tool module 21 having the smallest difference from the calculated value is recognized as the coupled module 21;
On radio contact between a tool module 21 and the reception module 22, information on the positioning of the tool module 21 is received at the tool 30, 30′, 30″ from the attachment tool 30, 30′, 30″. A more exact calculation can be made on the basis of this information as to which accelerations are expected at the tool 30, 30′, 30″ in the coupling procedure and a higher accuracy can be achieved in the comparison of the received and calculated accelerations.

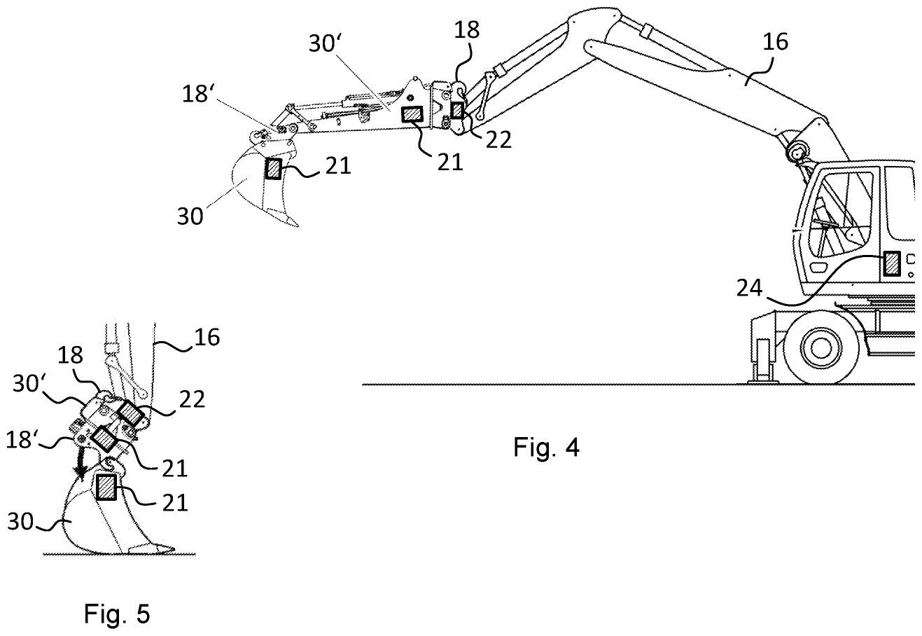

The method in accordance with the invention can likewise be used when a plurality of tools 30, 30′, 30″ were picked up together. An embodiment is shown in FIG. 4, for example, in which an arm extension 30′ is attached to the quick-changer 18 of the boom 16 that has its own quick-changer 18′ at its end remote from the boom 16, with an excavator bucket 30 in turn being attached to said quick changer 18′. FIG. 5 shows a further embodiment having a shorter adapter piece 18′ between the boom 16 and the excavator bucket 30.

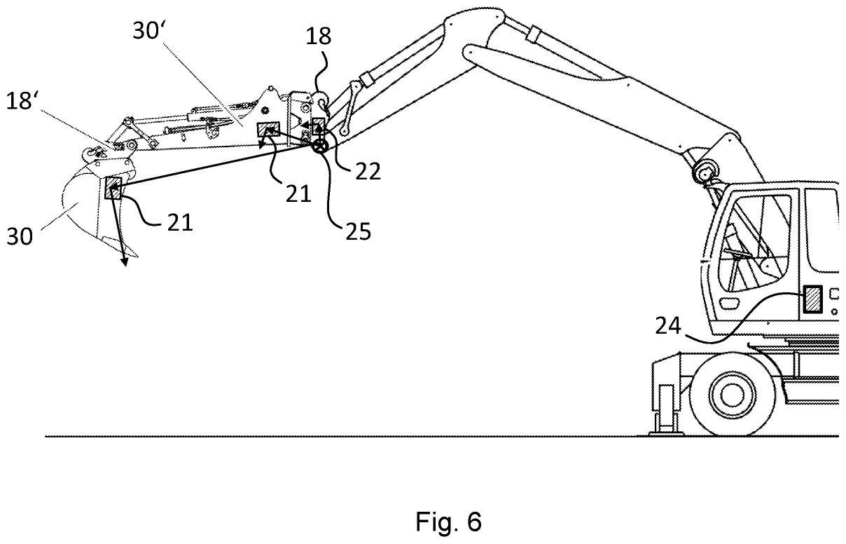

Different accelerations that depend on the geometry and on the kinematics of the attachment tools 30, 30′ act on the two tool modules 21 of the two attached tools 30, 30′ on a movement of the boom 16 (and also on a movement of only one or both attachment tools 30, 30′). This is shown in FIG. 6 by the drawn arrows that are drawn between the pivot joint 25 of the quick-changer 18 and the respective first and second communication units 21, 22. The accelerations at the respective fastening points of the communication units 21, 22 are each composed of the acceleration components between the pivot joint 26 and the communication unit 21, 22 and components perpendicular thereto. On a pivoting of the quick-changer 18, the arm extension 30′ and the excavator bucket 30 pivot together, with the latter being further remote from the pivot point 25. Greater acceleration points accordingly act on the excavator bucket 30 than on the arm extension 30′.

With a plurality of coupled tools 30, 30′, their attachment order can additionally be determined on the basis of the respective accelerations since the accelerations differ on the basis of the kinematics of the excavator 10 and of the tools 30, 30′, 30″. The correct determination of the coupling order permits an exact setting of the excavator 10 to the attached tools 30, 30′, 30″.

Plausibility evaluations can additionally be carried out by a comparison of the accelerations with theoretical, calculated accelerations. An evaluation can thereby be made whether the transmitted dimensions of an arm extension 30′ (that is the dimensions that are e.g. transmitted with the identification signals of the first communication unit 21) differ from the actual dimensions in that the measured accelerations are compared with the accelerations expected in accordance with the transmitted data.

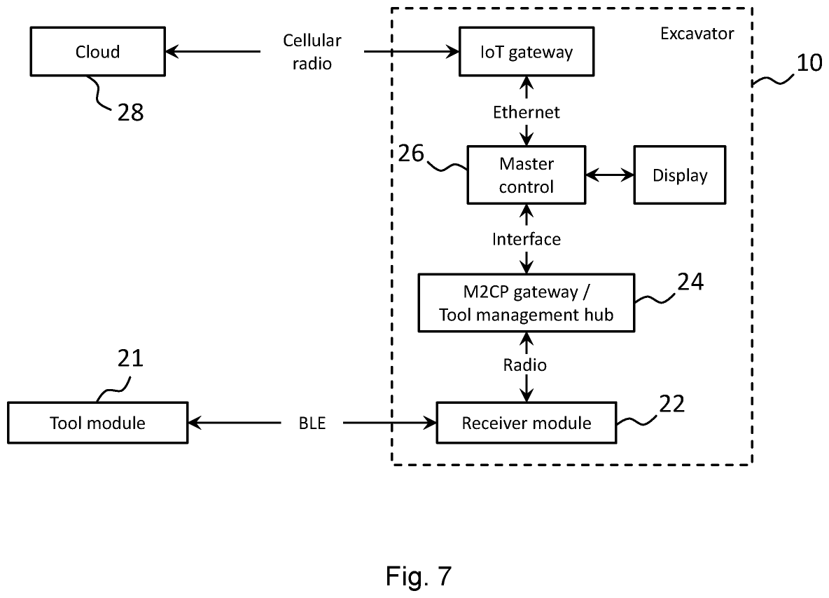

FIG. 7 shows a schematic diagram of the different components of the system in accordance with the invention in accordance with an embodiment. The tool module 21 connected to an attachment tool 30, 30′, 30″ communicates with the receiver module 22 at the excavator 10 via BLE. The communication between the receiver module 22 and the identification unit 24 centrally arranged in the excavator 10 takes place by radio, i.e. the data transmission can take place over a different radio standard than BLE. The identification unit 24 is connected to the vehicle control 26 via a corresponding interface so that data can be exchanged.

The vehicle control 26 is in turn connected to a cloud 28 via a communication module here: IoT gateway) by cellular radio. Data can therefore be exchanged between the cloud 28 and the vehicle control 26 or the identification unit 24 (for example, information can be called up from the cloud 28 or data can be stored therein).

### REFERENCE NUMERAL LIST

10 excavator
12 undercarriage
14 superstructure
16 boom
18 connection region (quick-changer)
18′ connection region (quick-changer)
20 transmission range
21 first communication unit
22 second communication unit
23 reception range
24 identification unit
25 pivot joint
26 control
28 cloud
30 attachment tool
30′ attachment tool
30″ attachment tool

1. A system for localizing an attachment tool for a work device, the system comprising:
a first communication unit connected to an attachment tool and having a first acceleration sensor configured to provide a first acceleration signal relating to an instantaneous acceleration of the attachment tool;
a second communication unit connected to the work device in a connection region for the attachment tool and having a second acceleration sensor configured to provide a second acceleration signal relating to an instantaneous acceleration of the connection region; and
an identification module that is coupled to one or more of the first or second communication unit and that is configured to obtain the first and second acceleration signals and to enable a safe allocation of the attachment tool to the work device by evaluating the first and second acceleration signals.

2. The system in accordance with claim 1, wherein the first communication unit is configured to wirelessly transmit the first acceleration signal to a reception unit wirelessly, with the reception unit configured to receive signals within a limited reception radius.

3. The system in accordance with claim 2, wherein the second communication unit comprises the reception unit and is configured to provide the first and second acceleration signals to the identification module; and wherein the second communication unit comprises the identification module or an identification unit connected to the work device that comprises the identification module and is configured to receive the first and second acceleration signals from the second communication unit in a wired or wireless manner.

4. The system in accordance with claim 2, further comprising:
an identification unit connected to the work device, the identification unit comprising the identification module and the reception unit; and wherein the second communication unit is configured to transmit the second acceleration signal to the identification unit in a wired or wireless manner.

5. The system in accordance with claim 1, wherein the first communication unit is configured to provide an identification signal relating to one or more of a location, a dimension, a type, or another property of the attachment tool and to transmit the identification signal to one or more of the identification module or a control of the work device.

6. The system in accordance with claim 1, wherein the identification module is configured to take account of one or more pieces of information in comparing the first and second acceleration signals, the one or more pieces of information comprising one or more of:
a property of a radio connection of the first communication unit;
an instantaneous location of the attachment tool;
a position of the first communication unit at an attachment tool;
an instantaneous position of the work device; or
an instantaneous coupling state of the attachment tool with the connection region of the work device.

7. The system in accordance with claim 1, wherein the identification module is configured to receive the first acceleration signal from the first communication unit of each of plural ones of the attachment tool and to compare each of the first acceleration signals with the second acceleration signal of the second communication unit to determine one or more of whether the attachment tool or which of plural ones of the attachment tool is connected to the work device.

8. The system in accordance with claim 7, wherein the identification module is configured to take account of one or both criteria in determining one or more of whether the attachment tool or which of the attachment tools is connected to the work device (10), the one or both criteria including:
a first difference between the first and second acceleration signals; or
a second difference between the second acceleration signal and an expected acceleration for the attachment tool calculated with reference to the second acceleration signal.

9. The system in accordance with claim 1, wherein at least two of the first communication unit are connected to different ones of the attachment tool that are one or more of coupled with one another or coupled with the connection region, the identification module configured to obtain the first acceleration signals of the at least two first communication units and to one or more of compare the first acceleration signals with one another or compare the first acceleration signals with the second acceleration signal to determine an attachment order of the attachment tools.

10. The system in accordance with claim 1, wherein at least two of the first communication unit are provided at respective different ones of the attachment tools that communicate with one another.

11. The system in accordance with claim 1, wherein the identification module is configured to calculate an expected acceleration for the attachment tool based on the second acceleration signal and to compare the expected acceleration with the first acceleration signal of the first communication unit of the attachment tool to one or more of recognize whether the attachment tool is connected to the work device or carry out a plausibility evaluation for an assumed equipment state of the work device.

12. A set of a work device and at least one attachment tool comprising a system in accordance with claim 1.

13. A method comprising:
detecting a first instantaneous acceleration of an attachment tool using a first acceleration sensor of a first communication unit connected to the attachment tool and providing a first acceleration signal;
detecting a second instantaneous acceleration of a connection region of the work device using a second acceleration sensor of a second communication unit and providing a second acceleration signal;
transmitting the first and second acceleration signals to the identification module; and
comparing the first and second acceleration signals to verify connection of the attachment tool to the work device.

14. The method in accordance with claim 13, wherein at least two of the first communication unit are provided that are connected to different ones of the attachment tools, with the attachment tools being couplable to one or more of one another or the connection region, with expected acerbations of the at least two attachment tools calculated based on the second acceleration signal and compared with the first acceleration signals of the at least two first communication units of the attachment tools to one or more of recognize whether one or more of the attachment tools are connected to the work device or carry out a plausibility evaluation for an assumed equipment state or for an equipment state of the work device transmitted by the first communication unit.

15. The method in accordance with claim 14, wherein information relating to one or more of a location, a dimension, a type, or another property of the attachment tools is transmitted to the identification module by the respective first communication units and is taken into account for the plausibility evaluation.
